(19) United States
(12) Patent Application Publication
(10) Pub. No.: US 2011/0146489 A1
(43) Pub. Date: Jun. 23, 2011

(54) AMMONIA REMOVAL, FOLLOWING REMOVAL OF CO2, FROM A GAS STREAM

(75) Inventors: Sanjay Kumar Dube, Knoxville, TN (US); Peter Ulrich Koss, Zollikon (CH); David James Muraskin, Knoxville, TN (US)

(73) Assignee: ALSTOM Technology Ltd, Baden (CH)

(21) Appl. No.: 12/944,106

(22) Filed: Nov. 11, 2010

Related U.S. Application Data
(60) Provisional application No. 61/287,222, filed on Dec. 17, 2009.

(51) Int. Cl. B01D 53/14; B01D 53/46

(52) U.S. Cl. 95/199; 96/234; 96/242

(57) ABSTRACT

A process for removal of CO₂ from a gas stream, comprising the steps of: (a) contacting in a CO₂ absorption stage a gas stream comprising CO₂ with a first absorption liquid comprising ammonia; (b) passing used absorption liquid resulting from step (a) to regeneration; (c) regenerating the first absorption liquid by releasing CO₂ from used absorption liquid and returning the first absorption liquid to step (a); (d) supplying CO₂ released from step (c) to a second absorption liquid; (e) contacting in a contaminant absorption stage the gas stream leaving step (a) with the second absorption liquid; and (f) withdrawing a portion of used absorption liquid resulting from step (e) and passing said liquid portion to regeneration in step (c), before recycling used absorption liquid resulting from step (e) as second absorption liquid to step (d).

### CROSS-REFERENCE TO RELATED APPLICATIONS

This application claims the benefit of U.S. Provisional Patent Application No. 61/287,222, filed Dec. 17, 2009 and entitled “Ammonia Removal, Following Removal Of CO2 From A Gas Stream”, which is incorporated by reference herein in its entirety.

### TECHNICAL FIELD

The present application relates to a process for removal of CO₂ from a gas stream and to a multi-stage absorber system for removal of CO₂ from a gas stream. After removal of CO₂, ammonia is removed from the gas stream by absorption in an absorption liquid.

### BACKGROUND

In processes used for industrial separation of acidic components such as H₂S, CO₂, COS and/or mercaptans from a gas stream such as flue gas, natural gas, syngas or other gas streams mainly containing nitrogen, oxygen, hydrogen, carbon monoxide and/or methane, liquid solutions comprising amine compounds or aqueous ammonia solutions are commonly used as a solvent. The acidic components are absorbed in the solvent in an absorption process. This process may be generally referred to as the main scrubbing process.

After “scrubbing” of said acidic components by said solutions, contaminants, such as traces of ammonia, amine compounds or degradation products of amine compounds, remain in the gas stream. These contaminants have to be removed from the gas stream.

Currently known systems and methods provide for the removal of these contaminants from a gas stream in a water wash step. In the water wash step, the gas stream is scrubbed with water in a suitable contacting device. Typically, the water used to scrub the gas stream is either fresh water or water obtained from a stripping process related to the treatment of the gas stream. After the gas stream is scrubbed with water, the water is 1) sent back to the stripping unit from which it was obtained or 2) simply mixed with the solution used in the main scrubbing process.

WO 2006/022885 (U.S. patent application Ser. No. 11/632,537, filed Jan. 16, 2007, and which is incorporated by reference herein in its entirety) discloses one such method of removing carbon dioxide from a flue gas, which method includes capturing carbon dioxide from the flue gas in a CO₂ absorber by means of an ammoniated solution or slurry. The CO₂ is absorbed by the ammoniated solution in the absorber at a reduced temperature of between about 0° C. and 20° C., after which the ammoniated solution is regenerated in a regenerator under elevated pressure and temperature to allow the CO₂ to escape the ammoniated solution as gaseous carbon dioxide of high purity.

U.S. Pat. No. 5,378,442 discloses a method for recovering carbon dioxide by absorbing carbon dioxide present in a combustion exhaust gas using an aqueous alkanolamine solution, comprising the step of bringing a combustion exhaust gas from which carbon dioxide has been absorbed and removed into contact with water containing carbon dioxide. It is taught that contact of the treated exhaust gas with water containing CO₂ permits the effective removal of ammonia from the treated exhaust gas (exhaust gas after the absorption of CO₂) and that part of recovered CO₂ can be used to easily increase the concentration of dissolved CO₂. The CO₂-containing water is brought into contact with the treated exhaust gas at the top of an absorbing column using an ordinary gas-liquid contact method which uses a tray, so as to absorb ammonia present therein, and the water containing ammonia is then led to effluent treating facilities or the like installed outside the CO₂ absorbing and recovering system.

Regeneration of used wash liquids, for example in a stripping unit, is generally an energy intensive, and thus expensive, process. Leading used absorption liquid to an external effluent treating facility is on the contrary to the general environmental desire to close industrial processes, and results in high water consumption. Thus, there is a need for improvements as regards the handling of wash and/or absorption liquids.

### SUMMARY

It is an object to provide an improved manner for handling of a wash and/or absorption liquid in a process or a system for removal of CO₂ from a gas stream.

Another object, related to the above mentioned object, is to reduce the costs of a process or a system for removal of CO₂ from a gas stream by an improved manner of recycling a wash and/or absorption liquid in such a process or system.

Other objects may be to obtain environmental, health and/or economical benefits of reduced emission of chemicals used in a gas purification process or system.

According to aspects illustrated herein, there is provided a process for removal of CO₂ from a gas stream, comprising the steps of:
(a) contacting in a CO₂ absorption stage a gas stream comprising CO₂ with a first absorption liquid comprising ammonia, to remove CO₂ from the gas stream;
(b) passing used absorption liquid resulting from step (a) to regeneration;
(c) regenerating the first absorption liquid by releasing CO₂ from used absorption liquid and returning the first absorption liquid to step (a);
(d) supplying CO₂ released from step (c) to a second absorption liquid;
(e) contacting in a contaminant absorption stage the gas stream leaving step (a) with the second absorption liquid, to remove ammonia from the gas stream; and
(f) withdrawing a portion of used absorption liquid resulting from step (e) and passing said liquid portion to regeneration in step (c), before recycling used absorption liquid resulting from step (e) as second absorption liquid to step (d).

In this process, the CO₂ supplied to the second absorption liquid is CO₂ released by regeneration of a first absorption liquid obtained from removal of CO₂ from a gas stream, said removal comprising the step of contacting said gas stream with a first absorption liquid comprising ammonia or an amine compound.

Thus, it is allowed for elimination of a water wash and stripper process conventionally following a CO₂ absorption stage. Consequently, it is allowed for savings in respect of equipment as well as in operational costs, mainly energy costs, associated with the operation of a water wash unit and its stripper. By recycling of the used absorption liquid leaving the contaminant absorption step the amount of liquid used may be lowered, possibly resulting in lowered costs and lowered environmental impact.

The term “contaminant”, as used herein, refers generally to an undesired component present in a gas stream. The contaminant will generally be present in a minor amount by volume in the gas stream. The contaminant may be undesired e.g. because it lowers the usefulness of the gas stream in a subsequent application or further treatment process or because it imparts undesirable properties to the gas stream, such as toxicity, environmental disadvantages, odors, etc. An example of a contaminant is ammonia. Thus, a “contaminant absorption stage” or a “contaminant absorber” refers to a process or a device for absorption of such a contaminant.

Alkaline compounds are often used in absorption processes for removal of acidic gases, such as CO₂, H₂S and COS from gas streams, such as in step (a). Step (e) provides for the removal of alkaline contaminants from gas streams. At least one of the contaminants to be removed is ammonia. The supply of CO₂ to the second absorption liquid prior to use in an contaminant absorption stage results in a substantial improvement of the efficiency of the absorption stage for the removal of alkaline contaminants such as e.g. ammonia. Although the present invention is not bound by any particular scientific explanation, a contributing factor in this substantial improvement may be a shift of the pH value in the absorption liquid to the acidic side caused by the dissolution of CO₂ in the absorption liquid as carbonic acid. Generally, the contaminants introduced in the gas stream through the first absorption liquid being used in the main scrubbing process have a caustic or slightly caustic character. As such, the vapor/liquid equilibrium of the respective contaminant can be improved if the pH value of the water is shifted to the acidic side. However, the substantial improvement goes far beyond what could be attributed solely to such shift of the pH value.

The passing, in step (f), of a liquid portion of used absorption liquid to regeneration may occur when step (f) is performed without substantially releasing ammonia from the used absorption liquid resulting from step (e). In this context it is clear to a skilled person that the phrase “without substantially releasing” allows for, e.g., minor leakages or discharges of ammonia, whereas, e.g., gas/liquid fractionation of the used absorption liquid resulting from step (e), in order to send a gaseous stream of ammonia to regeneration, is not within the scope of step (f). As an example, no stripping of the used absorption liquid resulting from step (e), or of the portion of used absorption liquid resulting from step (e), takes place. The portion of used absorption liquid from step (e) passed to regeneration in step (c) is combined with used absorption liquid from the CO₂ absorption stage (a), possibly in a regenerator feed tank, in order to recover the captured ammonia in the regenerating step (c). The passing of a portion of used absorption liquid from step (e) passed to regeneration in step (c) will also maintain the desired CO₂ flow from regeneration step (c). The portion of used absorption liquid resulting from step (e) being withdrawn in step (f) may be a minor portion of used absorption liquid resulting from step (e). The minor portion may represent 25% or less, 10% or less, 5% or less or 1% or less of the used absorption liquid resulting from step (e).

The CO₂ introduced into the second absorption liquid may be in various physical forms. The CO₂ may for example be introduced in solid, liquid, supercritical fluid, or gas form, or a mixture thereof. It has been found that the CO₂ may conveniently be introduced into the second absorption liquid in liquid form. Thus, CO₂ released from step (c) may be transferred to liquid state before being supplied, in step (d), to the second absorption liquid. Said transfer may be performed or assisted by cooling of gaseous CO₂ released in step (c).

In order to account for reaction heat evolved by chemical reactions occurring during step (e), e.g., heat of the NH₃—CO₂—H₂O reaction, and to decrease CO₂ vapor release from the second absorption liquid during step (e), the second absorption liquid may be cooled before being contacted, in step (e), with the gas stream leaving step (a).

The contacting of the gas stream containing contaminants to be removed with the second absorption liquid to allow absorption of the contaminants into the second absorption liquid may be brought about in various arrangements, which will be readily recognizable to a person skilled in the art. It has been found that especially efficient absorption is achieved when in step (e) the gas stream is contacted with the second absorption liquid in a counter current flow. To accommodate precipitated solids, the contaminant absorption stage of step (e) may comprise a mass transfer device of a suitable liquid/gas contacting design, preferably of a tray design.

The recited process is applicable when the CO₂ absorption stage (a) is operated according to the so-called chilled ammonia process wherein the he flue gas is cooled below ambient (room) temperature before entering the CO2 absorption tower. For example, the flue gas may be cooled below 25° C., preferably below 20° C., and optionally below 10° C. in step (a). An ammoniated solution or slurry may be used as the CO₂ absorption liquid, which may be cooled, for example, below 25 C, preferably below 20 C, and optionally below 100.

It is contemplated that the recited process is applicable also when the CO₂ absorption stage (a) is operated according to an amine based process. In other words, the recited process may be operated in a manner wherein in step (a) the first absorption liquid comprises an amine compound and wherein in step (e) ammonia, an amine compound or a decomposition product of an amine compound is removed. Examples of amine compounds include, but are not limited to, monoethanolamine (MEA), diethanolamine (DEA), methyldiethanolamine (MDEA), diisopropylamine (DIPA) and aminoethoxyethanol (diglycolamine) (DGA). The most commonly used amines compounds in industrial plants are the alkanolamines MEA, DEA, and MDEA. It is further contemplated that the absorption liquid may also include a promoter to enhance the chemical reaction kinetics involved in the capture of CO₂ by the ammoniated solution. For example, the promoter may include an amine (e.g. piperazine) or an enzyme (e.g., carbonic anhydrase or its analogs), which may be in the form of a solution or immobilized on a solid or semi-solid surface.

Step (e) and step (a) may be performed in a common vessel. Step (e) may be performed above the performance of step (a) in a common absorption column. Such arrangements allow for material and cost savings.

Features mentioned in respect of the above aspect may also be applicable to the aspect of the invention described below.

According to other aspects illustrated herein, there is provided a multi-stage absorber system for removal of CO₂ from a gas stream having a flow direction, comprising

a CO₂ absorber for contacting a gas stream comprising CO₂ with a first absorption liquid,

a regenerator for regenerating the first absorption liquid by releasing CO₂ from used absorption liquid,

a first conduit connecting the CO₂ absorber and the regenerator for passing used absorption liquid to the regenerator, and

a second conduit connecting the regenerator and the CO₂ absorber for returning the first absorption liquid to the CO₂ absorber; and downstream of the CO₂ absorber in respect of the flow direction of the gas stream

a contaminant absorber for contacting the gas stream with a second absorption liquid, and

a recycling circuit connecting a liquid outlet and a liquid inlet of the contaminant absorber for recycling of used absorption liquid as second absorption liquid to the contaminant absorber; the multi-stage absorber system further comprising

a CO₂ conduit connecting the regenerator and the recycling circuit for supplying CO₂ released from the regenerator to the second absorption liquid, and

a liquid conduit connecting the recycling conduit and the regenerator for passing a portion of the used absorption liquid from the contaminant absorber to the regenerator.

The term “liquid conduit” refers to a conduit adapted and intended for passing of a liquid from the contaminant absorber to the regenerator. A liquid is passed through the liquid line, e.g., when the recycling circuit and the liquid conduit are void of equipment, such as a stripper, for transferring the used absorption liquid or the portion of the used absorption liquid to gaseous state.

Means for supplying CO₂ into the second absorption liquid may be adapted for introducing CO₂ in solid, liquid supercritical fluid, or gaseous form into the second absorption liquid. CO₂ in liquid form may for example be introduced into the second absorption liquid via an injection nozzle. Thus, the CO₂ conduit may comprise means, such as a cooler, for liquefying CO₂.

As considered above, reaction heat may evolve in the contaminant absorber. To account for that, and for decreasing CO₂ vapor release in the contaminant absorber, the recycling circuit may comprise a cooler.

The design of the mass transfer device of the contaminant absorber has been discussed above. Thus, the contaminant absorber may be a counter current absorber. In order to accommodate precipitated solids, the contaminant absorber may comprise a mass transfer device of a suitable liquid/gas contacting design, preferably of a tray design.

It is applicable to operate the recited multi-stage absorber system according to the so-called chilled ammonia process. Thus, the CO₂ absorber may be adapted for operation below ambient temperature. For example, at a temperature below 25° C., preferably below 20° C., and optionally below 10° C.

It is contemplated that it is applicable to operate the recited multi-stage absorber system also according to a amine based process. Thus, the CO₂ absorber may be adapted for contacting a gas stream comprising CO₂ with a first absorption liquid comprising an amine compound, and the contaminant absorber may be adapted for contacting the gas stream with a second absorption liquid for absorption of ammonia, an amine compound or a decomposition product of an amine compound.

The contaminant absorber and the CO₂ absorber may be arranged in a common vessel. The contaminant absorber may be arranged above the CO₂ absorber in a common absorption column. Such arrangements allow for material and cost savings.

The above described and other features are exemplified by the following figure and detailed description.

### BRIEF DESCRIPTION OF THE DRAWINGS

Referring now to the figure, which is an exemplary embodiment:

FIG. 1 is a diagram generally depicting an ammonia based system for removal of CO₂ from a gas stream.

### DETAILED DESCRIPTION

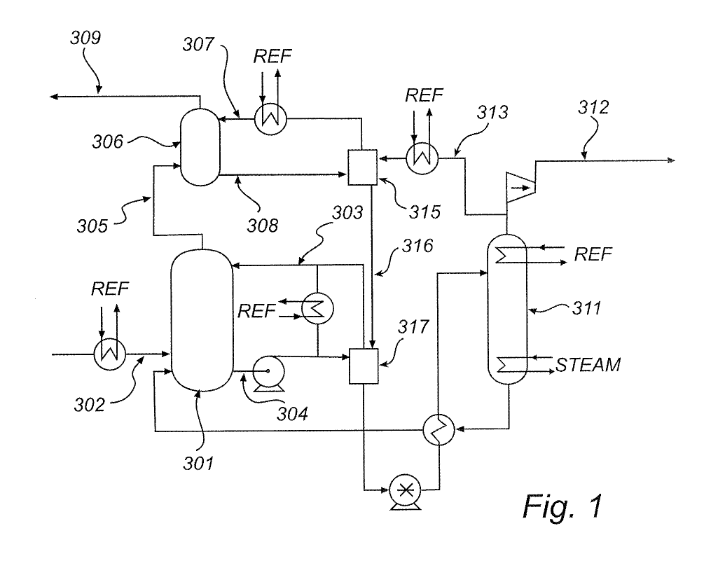

FIG. 1 illustrates a multi-stage absorber system for removal of CO₂ from a gas stream. The system comprises a CO₂ absorber 301 arranged to allow contact between a gas stream to be purified and a first absorption liquid comprising ammonia. A gas stream from which CO₂ is to be removed, is fed to the CO₂ absorber 301 via line 302. In the CO₂ absorber the gas stream is contacted with an absorption liquid comprising ammonia, e.g. by bubbling the gas stream through said absorption liquid or by spraying the absorption liquid into the gas stream. The first absorption liquid comprising ammonia is fed to the CO₂ absorber 301 via line 303. In the CO₂ absorber, CO₂ from the gas stream is absorbed in the absorption liquid, e.g. by formation of carbonate or bicarbonate of ammonium either in dissolved or solid form. Used absorption liquid containing absorbed CO₂ leaves the absorber via line 304 and is brought to a regenerator, i.e. a stripping unit, 311 where CO₂ is released from the used absorption liquid and the first absorption liquid is regenerated. Regenerated first absorption liquid is returned to the CO₂ absorber 301. The released CO₂ leaves the regenerator 311 via line 312. A gas stream depleted of CO₂ leaves the CO₂ absorber via line 305.

The system represented by FIG. 1 further comprises a contaminant absorber 306. The contaminant absorber is arranged to allow contact between the gas stream depleted of CO₂ which leaves the CO₂ absorption unit 301 via the line 305 and a second absorption liquid. The second absorption liquid is fed to the contaminant absorber via a line 307. In the contaminant absorber unit, ammonia remaining in the gas stream when it leaves the CO₂ absorber 301 is absorbed in the second absorption liquid. Used absorption liquid containing absorbed ammonia leaves the contaminant absorber via a line 308. A gas stream depleted of CO₂ and ammonia leaves the contaminant absorber 306 via a line 309.

The used absorption liquid leaving the contaminant absorber 306 via the line 308 is recycled via a feed tank 315 and the line 307 to the contaminant absorber 306. A cooler in line 307 accommodates for the heat of the NH₃—CO₂—H₂O reaction and cools the second absorption liquid to decrease CO₂ vapor in the contaminant absorber 306. In the feed tank 315, CO₂ released from the regenerator 311 is supplied via a line 313 to the second absorption liquid. With assistance of a cooler in line 313, CO₂ supplied to the feed tank 315 is liquid. From the feed tank 315, a bleed stream of the second absorption liquid is sent via a line 316 to a regenerator feed tank 317 and further to the regenerator 311 in order to recover the captured ammonia in the regenerator.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A process for removal of CO₂ from a gas stream, comprising the steps of:
(a) contacting in a CO₂ absorption stage a gas stream comprising CO₂ with a first absorption liquid comprising ammonia, to remove CO₂ from the gas stream;
(b) passing used absorption liquid resulting from step (a) to regeneration;
(c) regenerating the first absorption liquid by releasing CO₂ from used absorption liquid and returning the first absorption liquid to step (a);
(d) supplying CO₂ released from step (c) to a second absorption liquid;
(e) contacting in a contaminant absorption stage the gas stream leaving step (a) with the second absorption liquid, to remove ammonia from the gas stream; and
(f) withdrawing a portion of used absorption liquid resulting from step (e) and passing said liquid portion to regeneration in step (c), before recycling used absorption liquid resulting from step (e) as second absorption liquid to step (d).

2. The process according to claim 1, wherein step (f) is performed without substantially releasing ammonia from the used absorption liquid resulting from step (e).

3. The process according to claim 1, wherein the portion of used absorption liquid resulting from step (e) being withdrawn in step (f) is a minor portion of used absorption liquid resulting from step (e).

4. The process according to claim 1, wherein CO₂ released from step (c) is transferred to liquid state before being supplied, in step (d), to the second absorption liquid.

5. The process according to claim 1, wherein the second absorption liquid is cooled before being contacted, in step (e), with the gas stream leaving step (a).

6. The process according to claim 1, wherein in step (e) the gas stream is contacted with the second absorption liquid in a counter current flow.

7. The process according to claim 1, wherein the contaminant absorption stage of step (e) comprises a mass transfer device of a tray design.

8. A multi-stage absorber system for removal of CO₂ from a gas stream having a flow direction, comprising
a CO₂ absorber for contacting a gas stream comprising CO₂ with a first absorption liquid,
a regenerator for regenerating the first absorption liquid by releasing CO₂ from used absorption liquid,
a first conduit connecting the CO₂ absorber and the regenerator for passing used absorption liquid to the regenerator, and
a second conduit connecting the regenerator and the CO₂ absorber for returning the first absorption liquid to the CO₂ absorber;
and downstream of the CO₂ absorber in respect of the flow direction of the gas stream
a contaminant absorber for contacting the gas stream with a second absorption liquid, and
a recycling circuit connecting a liquid outlet and a liquid inlet of the contaminant absorber for recycling of used absorption liquid as second absorption liquid to the contaminant absorber;
the multi-stage absorber system further comprising
a CO₂ conduit connecting the regenerator and the recycling circuit for supplying CO₂ released from the regenerator to the second absorption liquid, and
a liquid conduit connecting the recycling conduit and the regenerator for passing a portion of the used absorption liquid from the contaminant absorber to the regenerator.

9. The multi-stage absorber system according to claim 8, wherein the recycling circuit and the liquid conduit are void of equipment for transferring the used absorption liquid or the portion of the used absorption liquid to gaseous state.

10. The multi-stage absorber system according to claim 8, wherein the CO₂ conduit comprises means for liquefying CO₂.

11. The multi-stage absorber system according to claim 8, wherein the recycling circuit comprises a cooler.

12. The multi-stage absorber system according to claim 8, wherein the contaminant absorber is a counter current absorber.

13. The multi-stage absorber system according to claim 8, wherein the contaminant absorber comprises a mass transfer device of a tray design.

14. The multi-stage absorber system according to claim 8, wherein the CO₂ absorber is adapted for contacting a gas stream comprising CO₂ with a first absorption liquid comprising ammonia, and wherein the contaminant absorber is adapted for contacting the gas stream with a second absorption liquid for absorption of ammonia.

15. The multi-stage absorber system according to claim 8, wherein the contaminant absorber is arranged above the CO₂ absorber in a common absorption column.
